(19) United States
(12) Patent Application Publication
(10) Pub. No.: US 2014/0346020 A1
(43) Pub. Date: Nov. 27, 2014

(54) OPERATOR CONTROL DEVICE WITH PUSH BUTTONS, IN PARTICULAR, A REMOTE KEY FOB WITH PUSH BUTTONS FOR MOTOR VEHICLES

(71) Applicant: Hella KGaA Hueck & Co., Lippstadt (DE)

(72) Inventors: Tobias Heine, Lippstadt (DE); Sebastian Stork, Buren (DE)

(21) Appl. No.: 14/284,800

(22) Filed: May 22, 2014

(30) Foreign Application Priority Data
May 22, 2013 (DE) 102013105195.2

(51) Int. Cl. H01H 13/06

(52) U.S. Cl. CPC H01H 13/06; H01H 2231/026; H01H 2231/032
USPC 200/302.2

(57) ABSTRACT

An operator control device with push buttons (1), in particular a remote key fob for motor vehicles. The operator control device comprises a housing and at least one push button (1), which is mounted in the housing in such a way that it can move between stops (2, 8), and which penetrates a cutout in the housing. The cutout is defined by an edge (6), wherein the edge (6) extends into the interior of the housing with at least one section.

### CROSS REFERENCE

This application claims priority to German Patent Application No. 10 2013 105195.2, filed May 22, 2013, which is hereby incorporated by reference.

### FIELD OF THE INVENTION

The invention relates to an operator control device with push buttons, in particular, a remote key fob for motor vehicles, wherein said operator control device comprises a housing and at least one push button, which is mounted in the housing in such a way that it can move between stops, and which penetrates a cutout in the housing, wherein the cutout is defined by an edge.

### BACKGROUND

Motor vehicle remote key fobs that have push buttons for locking and unlocking vehicle doors, for opening the trunk lid, etc. are very popular at the present time and are offered in various designs and for different vehicle models.

With respect to the mechanical construction there are two basic designs.

For example, there are remote key fob models with push buttons, which are formed by a flexible membrane and are integrally molded on the edge of the recess in the housing or are firmly connected to the edge of the recess in some other way. These membrane push buttons extend over the electric momentary contact switch or electric switch, where the elasticity of the membrane makes it possible to operate such a switch.

Furthermore, there are remote key fobs with push buttons that are connected to the housing only in a form fitting manner.

Prior art FIG. 1 shows in schematic form a sectional view of such a push button.

The push button 1 has at least one protruding element 3, 5 on an interior end. This protruding element extends under the edge of the cutout of the housing, so that the push button 1 is held and guided in the cutout. When the push button 1 is not actuated, the protruding element 3 strikes the edge 6 of the cutout in the housing. A second stop 8 is provided in the housing. The protruding element 3 also strikes this second stop.

In this kind of remote key fob there is a gap 7 between the push button 1 and the edge of the housing. No dirt, in particular dust or sand, or moisture can penetrate through this gap 7 into the housing. As long as this dirt has settled in the gap 7, this dirt can be easily recognized from the outside, a feature that significantly reduces the optical impression that such a key can leave behind. In addition, if this dirt has already penetrated into the housing, this dirt can also have an adverse effect on the mechanical and/or electrical function of the key.

The same problems can also develop in other operator control elements with push buttons, such as, for example, in mobile or wireless telephones, pocket calculators, remote control units, etc.

### SUMMARY OF THE INVENTION

It is at this point that the present invention begins.

The object of the present invention is to improve operator control devices exhibiting the features described in the introductory part of the specification in such a way that dirt is prevented from penetrating into the housing or that at least the penetration of dirt into the housing is made difficult.

This engineering object is achieved in accordance with the invention by the fact that the edge extends into the interior of the housing with at least one section. As a result, the edge that defines the cutout is drawn into the housing. This retracted edge of the cutout of the housing impedes the penetration of dirt and moisture. In addition, the net result is that it is possible to achieve the objective of an improved control of the push button by means of the housing.

Preferably the cutout is framed either entirely or partially by a part of the housing. It is advantageous that the operator control device according to the invention comprises an electric momentary contact switch or electric switch that is arranged adjacent to the push button and can be actuated by actuating the push button.

The push button can have at least one protruding element on an interior end; and this protruding element extends under the edge of the cutout. The at least one protruding element can be angled off in the opposite direction of a depressing movement of the push button, as a result of which the protection against the penetration of dirt and moisture into the housing is upgraded even more.

It is advantageous that the at least one protruding element forms together with the remaining push button a pocket. The housing edge that is drawn into the housing can dip into the pocket. This feature also improves the protection against the penetration of dirt and moisture into the housing.

In the non-depressed position of the push button a free end of the protruding element can strike a part of the inner face of the part of the housing that frames the cutout; and this region of the inner face can form a first stop.

It is advantageous that in the non-depressed position of the push button a free end of the retracted edge of the housing has no contact with the push button and, in particular, with the protruding element of the push button.

A second stop can be provided in the housing; and in the depressed state of the push button an inner face of the push button strikes this second stop. The second stop can be provided on one end of the protruding element that dips into a recess on the inner face of the push button.

Stop protrusions can be provided at the bottom and/or upper push button stops, not only at the push buttons but also at the housing. In this case it is advantageous that the dimensional change of said stop protrusions is in the range of a tenth of a millimeter, in order to adapt or rather to adjust by means of the design the travel distance of the push button when the push button is actuated. In addition, this arrangement allows selected stop areas of the momentary contact switch to be positioned with a degree of accuracy.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows in schematic form a sectional view of such a push button.

FIG. 2 is a top view of a remote key fob for a motor vehicle.

FIG. 3 is in schematic form as a sectional view of the remote key fob for a motor vehicle and with the push button in a non-depressed state; and

FIG. 4 is a sectional view in accordance with FIG. 3, but with the push button in the depressed state.

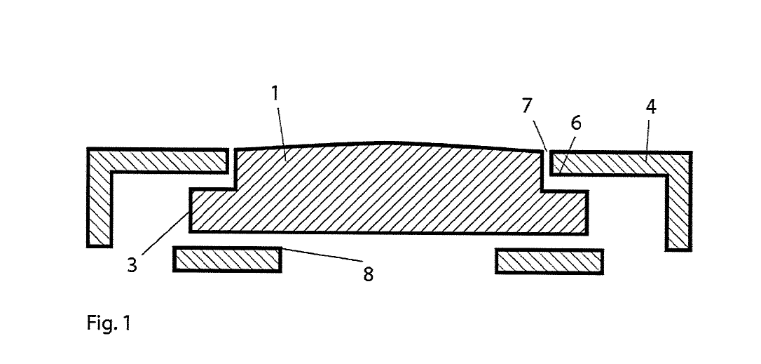

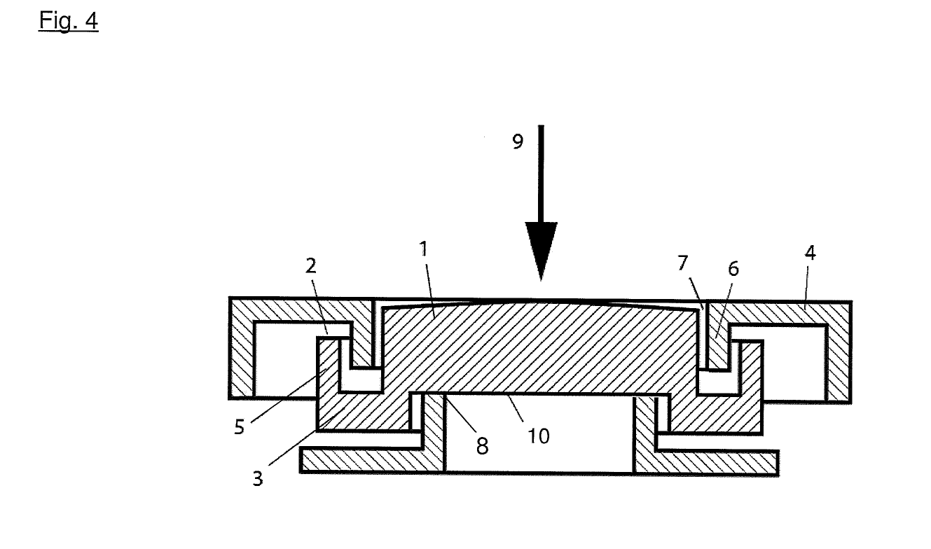

FIG. 1 shows a remote key fob for motor vehicles. In this case the remote key fob comprises a housing 4, in which electric momentary contact switches (not illustrated) are accommodated. When an electronic system (not illustrated) actuates said electric momentary contact switches in the housing 4, a radio signal is generated; and the remote key fob communicates by means of this radio signal with a counterpoint in a motor vehicle. This communication with the motor vehicle makes it possible to unlock or lock the motor vehicle. It is also possible to trigger additional functions in the motor vehicle. The functions that can be triggered depend on the configuration of the remote key fob and on the motor vehicle, which is not the subject matter of the present invention.

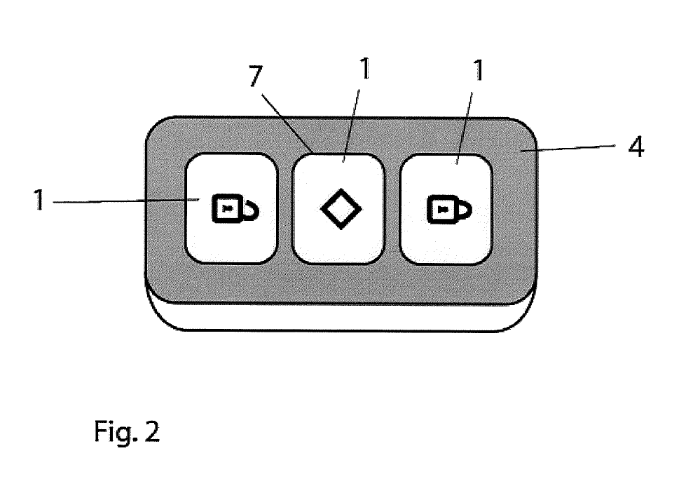

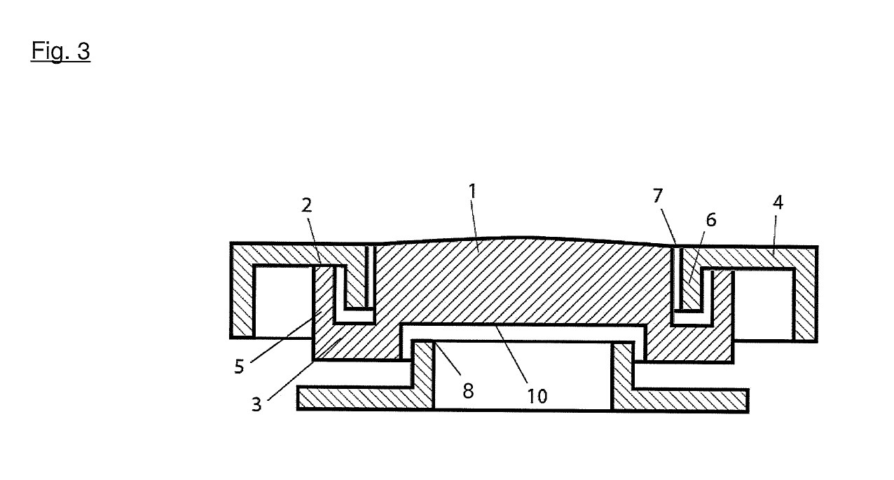

The electric momentary contact switches, which are provided in the housing 4, are actuated by means of push buttons 1 that are mounted in cutouts of the housing 4 in such a way that they can be displaced. The push buttons 1 are not connected to the housing 4 by material bonding. Between the push buttons 1 and the housing there is, therefore, a gap 7, in which dirt can settle and by means of which it is possible for dirt and moisture to penetrate into the housing 4. In addition, a look through the gap into the housing is not impeded. In order to prevent this, the push buttons 1 and the housing 4 are designed in an inventive manner, as can be seen in FIGS. 2 and 3.

At variance with the prior art push buttons shown in FIG. 1, the push buttons of a remote key fob according to the invention comprises a collar 3, which forms a first part of a protruding element 3, 5. Connected to this collar 3 is a leg 5, which is angled off by approximately 90° in the opposite direction of the depressing direction of the push button and forms together with the collar 3 and the remaining push button 1 a pocket. Insofar as the push button 1 and the cutout in the housing, in which the push button is arranged, have a circular cross section, the pocket is an annular slot in the push button 1.

The cutout in the housing 4, in which the push button 1 is disposed in such a way that it can be displaced, has an edge 6, which is drawn into the housing 4. This retracted edge 6 extends into the pocket, which is formed by the protruding element (reference numerals 3, 5) and the remaining push button 1.

The protruding element 3, 5 and the retracted edge 6 are designed in such a way that the edge 6 does not strike the protruding element, irrespective of the position, in which the push button 1 is located, i.e. irrespective of whether the push button 1 is actuated or not. In a non-actuated state the outwards pointing end of the protruding element 3, 5 or, stated more specifically, the free end of the leg 5, strikes a region 2 of the inner face of the housing 4.

In the actuated state of the push button 1 a recessed region 10 on the inner face of the push button 1 strikes a stop 8, which is formed by a protruding element that is provided in the interior of the housing 4 and is firmly connected to the housing 4.

This kind of mounting impedes or even prevents dirt and moisture from passing directly through the gap 7 between the push button 1 and the housing 4. In addition, the push button 1 is guided by means of the guide, which is formed by the retracted edge 6 and the pocket in the push button 1, so well that when the push buttons are actuated, said push buttons are prevented from shifting or jamming. The movement of the push button is defined by means of the stops 8, 2, so that especially when the push button is actuated, pressure cannot be exerted on the electronic momentary contact switch, which could be damaged if such a pressure were exerted.

In the case of the remote key fob according to the invention, the push button 1 and the housing 4 can be further modified to include, for example, additional mechanical functions, such as, for example, to integrate a push button lock into the remote key fob.

The upper and bottom push button stops (2/8) may be supplemented by stop protrusions (11), which are located at the stop areas (2/8) not only at the push buttons but also at the housing. It is advantageous that the stop protrusions (11) can be used to adjust by means of the design the travel distance of the push button on actuation (9) of the push button (1) and to achieve the ability to position accurately at certain points.

### LIST OF REFERENCE NUMERALS

1 push button
2 stop/region of the inner face of the housing
3 collar/part of the protruding element
4 housing
5 leg/part of the protruding element
6 edge of the cutout in the housing
7 gap
8 stop
10 recess on the inner face of the push button

1. An operator control device for motor vehicles comprising:
a housing and at least one push button, which is mounted in the housing in such a way that it can move between stops, and which penetrates a cutout in the housing, wherein the cutout is defined by an edge,
wherein the edge extends into the interior of the housing with at least one section.

2. The operator control device, as claimed in claim 1, wherein the push button has at least one protruding element on an interior end; and
wherein the protruding element extends under the edge of the cutout.

3. The operator device, as claimed in claim 2, wherein the at least one protruding element is angled off in the opposite direction of a depressing movement of the push button.

4. The operator control device, as claimed in claim 3, wherein the at least one protruding element forms together with the remaining push button a pocket.

5. The operator control device, as claimed in claim 3, wherein the edge of the housing that is drawn into the housing dips into the pocket.

6. The operator control device, as claimed in claim 3, wherein in a non-depressed position of the push button a free end of the protruding element strikes a part of the inner face of the part of the housing that frames the cutout;
and said region of the inner face forms a first stop.

7. The operator control device, as claimed in claim 1, wherein in a non-depressed position of the push button a free end of the retracted edge of the housing has no contact with the push button and, in particular, with the protruding element of the push button.

8. The operator control device, as claimed in claim 1, wherein a second stop is provided in the housing; and
in a depressed state of the push button an inner face of the push button strikes this second stop.

9. The operator control device, as claimed in claim 8, wherein the second stop is provided on one end of the protruding element that dips into a recess on the inner face of the push button.

10. The operator control device, as claimed in claim 1, further including a stop protrusion is provided at one or more of said stops.
